(19) United States
(12) Patent Application Publication
(10) Pub. No.: US 2017/0138324 A1
(43) Pub. Date: May 18, 2017

(54) FUEL FILTER

(71) Applicant: AISAN KOGYO KABUSHIKI KAISHA, Obu-shi (JP)

(72) Inventors: Masaki Ikeya, Obu-shi (JP); Yuichi Murakoshi, Inazawa-shi (JP)

(21) Appl. No.: 15/342,382

(22) Filed: Nov. 3, 2016

(30) Foreign Application Priority Data
Nov. 12, 2015 (JP) 2015-222396

(51) Int. Cl. F02M 37/22; B01D 29/01; B01D 29/05; B01D 35/00

(52) U.S. Cl. CPC F02M 37/22; B01D 35/005; B01D 29/014; B01D 29/05; B01D 2201/0415

(57) ABSTRACT

A fuel filter includes a pair of filter members facing each other and a frame. Outer peripheral edges of the filter members are closed. The frame is housed in the filter members. The frame maintains a gap between the pair of the filter members. The frame extends along a second direction perpendicular to a first direction in which the pair of the filter members face each other. The frame includes a plurality of first frame members and a second frame member. The plurality of the first frame members is disposed at intervals in a third direction perpendicular to the first direction and the second direction. The second frame member extends along the third direction and is connected to each of the first frame members. The flame has a greater strength in the second direction than in the third direction.

### TECHNICAL FIELD

The present disclosure relates to a fuel filter configured to remove foreign matter contained in fuel sucked into a fuel pump.

### DESCRIPTION OF RELATED ART

Japanese Patent Application Publication No. 2012-112333 discloses a fuel filter disposed in a fuel tank. The fuel filter disclosed in Japanese Patent Application Publication No. 2012-112333 is formed to have a bag shape by arranging a pair of filter members so as to face each other and welding their outer edges. A frame for maintaining a gap between the pair of the filter members is disposed inside the fuel filter.

### SUMMARY

In Japanese Patent Application Publication No. 2012-112333, a plurality of frames is disposed inside a filter such that the fuel filter is configured to bend. Each of the frames has a structure in which ribs protrude from a grid-like frame member. According to Japanese Patent Application Publication No. 2012-112333, the respective frames themselves do not bend, and thus flexibility of the fuel filter is restricted. Due to this, workability at a time of disposing the fuel filter into the fuel tank decreases. The present disclosure provides a technique by which flexibility of a fuel filter is improved.

The present disclosure relates to a fuel filter disposed in a fuel tank and configured to remove foreign matter contained in fuel sucked into a fuel pump. The fuel filter comprises a pair of filter members and a frame. The pair of the filter members faces each other and outer peripheral edges of which are closed. The flame is housed in the pair of the filter members and maintains a gap between the pair of the filter members. The frame comprises a plurality of first frame members and a second frame member. The first frame member extends along a second direction perpendicular to a first direction in which the pair of the filter members faces each other. Further, the first frame members are disposed at intervals in a third direction perpendicular to the first direction and the second direction. The second frame member extends along the third direction. Further, the second frame member is connected to each of the first frame members. In the fuel filter disclosed herein, the frame has a greater strength in the second direction than in the third direction.

In the aforementioned fuel filter, the flame has a greater strength in the second direction than in the third direction. Thus, the frame is difficult to bend in the second direction and is easy to bend in the third direction. In other words, by maintaining the rigidity of the frame in the second direction, flexibility of the frame in the third direction can be improved while securing the gap between the pair of the filter members. Compared to the conventional fuel filter, the aforementioned fuel filter is more flexible, and thus can improve the workability at a time of disposing the fuel filter into the fuel tank. Notably, in the present application, each of the “first direction”, “second direction”, and “third direction” means a direction in a state where the fuel filter is not bent. Thus, it is accordingly meant that in a state where the fuel filter is bent, the “third direction” is perpendicular to the “second direction”, but is not perpendicular to the “first direction”.

### BRIEF DESCRIPTION OF DRAWINGS

FIG. 1 shows a fuel supply device with a fuel filter of a first embodiment;

FIG. 2 shows the fuel filter of FIG. 1 in a view from a bottom side of the fuel supply device;

FIG. 3 shows a perspective view of the fuel filter of the first embodiment;

FIG. 4 shows a cross sectional view of the fuel filter along a line IV-IV of FIG. 3;

FIG. 5 shows a cross sectional view of the fuel filter along a line V-V of FIG. 4;

FIG. 6 shows a cross sectional view of the fuel filter along a line VI-VI of FIG. 4;

FIG. 7 shows an exploded perspective view of filter members of the first embodiment;

FIG. 8 shows a manufacturing process of the fuel filter of the first embodiment;

FIG. 9 shows a cross sectional view of a frame used in a fuel filter of a second embodiment;

FIG. 10 shows a cross sectional view of a flame used in a fuel filter of a third embodiment;

FIG. 11 shows a cross sectional view of a fuel filter of a fourth embodiment;

FIG. 12 shows a cross sectional view of the fuel filter along a line XII-XII of FIG. 11;

FIG. 13 shows a cross sectional view of a fuel filter of a fifth embodiment;

FIG. 14 shows a cross sectional view of the fuel filter along a line XIV-XIV of FIG. 13;

FIG. 15 shows a cross sectional view of a fuel filter of a sixth embodiment;

FIG. 16 shows a cross sectional view of the fuel filter along a line XVI-XVI of FIG. 15; and

FIG. 17 shows a bottom view of a fuel supply device with the fuel filter of the sixth embodiment.

### DETAILED DESCRIPTION

Now, some of features of the technique disclosed herein will be listed hereinbelow. Notably, each of the following features independently has technical utility.

A fuel filter is disposed in a fuel tank and is configured to remove foreign matter contained in fuel sucked into a fuel pump. The fuel filter may comprise a pair of filter members and a frame maintaining a gap between the pair of the filter members. The pair of the filter members may face each other and outer peripheral edges of which may be closed. The outer peripheral edges of the pair of the filter members may be closed so that a filter has a bag shape. The outer peripheral edges of the pair of the filter members may be closed by welding. Each of the pair of the filter members may have a laminated structure in which a plurality of filter elements is laminated. Each of the pair of the filter members may be a non-woven cloth. Further, the pair of the filter members may have a structure in which a single sheet (or a single sheet having a laminated structure) is folded in the middle and overlapped end portions are closed by welding. Alternatively, the pair of the filter members may have a structure in which two sheets are laid one on the other and an entire circumference of end portions is closed by welding and the like.

The frame is housed in the pair of the filter members and maintains the gap between the pair of the filter members. The frame may comprise a plurality of first frame members and a second frame member connected to each of the first frame members. Each of the first frame members may extend along a second direction perpendicular to a first direction in which the pair of the filter members faces each other. Further, the first frame members may be disposed at intervals in a third direction perpendicular to the first direction and the second direction. The second frame member may extend along the third direction. Further, the second frame member may be connected to each of the first frame members. Notably, the fuel filter may have a rectangular shape. In this case, the first direction may be a thickness direction of the fuel filter, the second direction may be a lateral direction of the fuel filter, and the third direction may be a longitudinal direction of the fuel filter.

The frame may have a greater strength in the second direction than in the third direction. The frame may have a greater strength in the second direction than in the third direction by making the first frame members have a greater strength than the second frame member. Specifically, the frame may have a greater strength in the second direction than in the third direction by making a length of each of the first frame members in the first direction (a thickness of each of the first frame members) longer than a length of the second frame member in the first direction (a thickness of the second frame member). Further, the frame may have a greater strength in the second direction than in the third direction by providing the second frame member with a bent portion bending toward the first direction between adjacent first frame members. Alternatively, the frame may have a greater strength in the second direction than in the third direction by providing a larger number of the first frame members than a number of the second frame member(s). For example, in a case where the frame comprises a plurality of the second flame members, an interval between adjacent ones of the second frame members may be wider than an interval between adjacent ones of the first frame members. As an example, the frame may comprise two second frame members and the second frame members may be connected to the first frame members at both ends of each of the first frame members. In this case, no second flame member is connected to a middle portion of each of the first frame members.

The first frame members may be provided with a flow path through which fuel moves in the third direction. The flow path may be a through hole penetrating the first frame members in the third direction. Further, the flow path may be a groove provided in a part of each of the first frame members and extending toward the first direction. Alternatively, a protrusion protruding toward the first direction may be provided on a part of at least one of the first frame members and a part where no protrusion is provided may function as the flow path. At least one of the first frame members may be provided with an extension portion extending toward the third direction and being not in contact with the adjacent first frame member. A plurality of the extension portions may be provided with at least one of the first frame members at intervals in the second direction.

### EMBODIMENTS

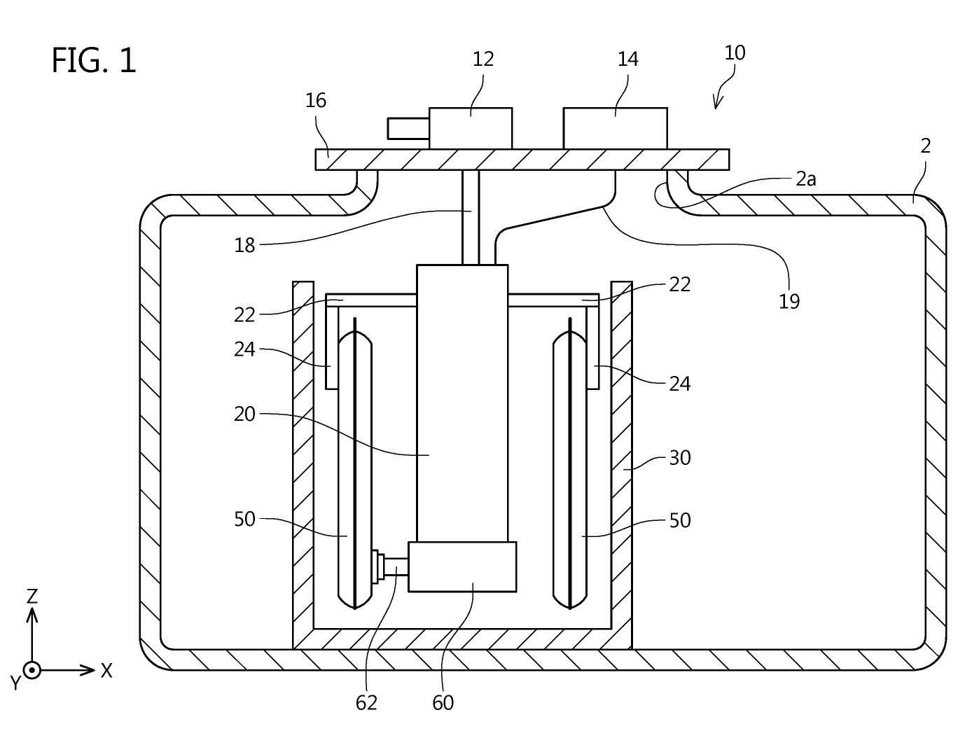

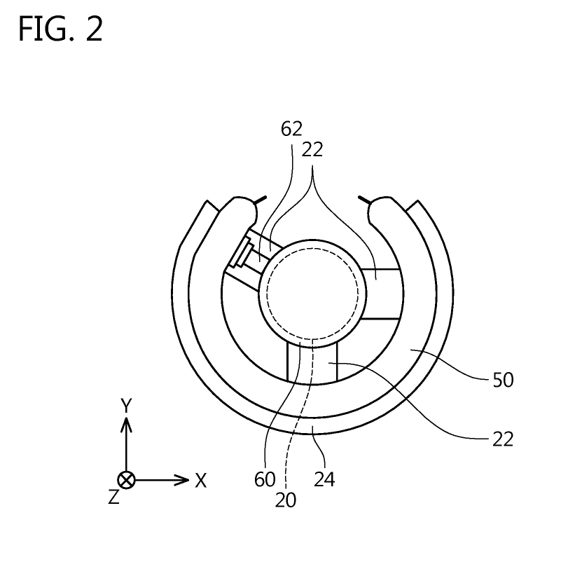

Referring to FIG. 1 and FIG. 2, a fuel supply device 10 using a fuel filter 50 of a first embodiment will be described. FIG. 1 shows a state where the fuel supply device 10 is mounted in a vehicle such as a car and the like. Regarding a fuel tank 2, a set plate 16, and a reserve cup 30 which are mentioned later, FIG. 1 shows a cross sectional view that is parallel to an X-Z plane cutting through a center of the set plate 16. Further, FIG. 2 shows a fuel pump 20 and the fuel filter 50 in a view from a bottom side of the fuel tank 2. The fuel supply device 10 is mounted in a vehicle such as a car and the like, and supplies fuel to an engine which is not shown. The fuel supply device 10 is disposed in the fuel tank 2. Fuel, such as gasoline or the like, is stored in the fuel tank 2. The fuel supply device 10 supplies the fuel stored in the fuel tank 2to the engine.

The fuel tank 2 is made of resin. The fuel tank 2 comprises an opening 2a in its upper wall. The opening 2a is used for disposing the fuel pump 20 of the fuel supply device 10 and the like into the fuel tank 2. Notably, the fuel tank 2 may be made of metal.

The fuel supply device 10 comprises the set plate 16, the fuel pump 20, the reserve cup 30, the fuel filter 50, and a lock wall 24. The set plate 16 is made of resin, and has a flat plate shape. The set plate 16 is disposed at an upper end of the opening 2a, and closes the opening 2a. The set plate 16 comprises a discharge port 12 and a case 14. The discharge port 12 and the case 14 are integrally formed with the set plate 16 on an upper surface of the set plate 16. The discharge port 12 is connected to the engine, and supplies to the engine fuel discharged from the fuel pump 20. The case 14 houses a control circuit which controls the fuel supply device 10.

One end of a supply pipe 18 is connected to the discharge port 12. The supply pipe 18 extends from the discharge port 12 to an inside of the fuel tank 2, penetrating the set plate 16. The other end of the supply pipe 18 is connected to the fuel pump 20. The fuel pump 20 has a cylindrical shape and its central axis extends parallel to a depth direction of the fuel tank 2 (hereinafter referred to as “Z axial direction”). That is, a height direction of the fuel pump 20 is same as the Z axial direction. The fuel pump 20 is a Wesco pump, and sucks fuel in the fuel tank 2 into the fuel pump 20 by rotation of an impeller, pressurizes the fuel, and then supplies the fuel from the discharge port 12 to the engine via the supply pipe 18. The fuel pump 20 is connected to the control circuit in the case 14 via a wire 19. The fuel pump 20 is controlled by the control circuit.

The fuel pump 20 is accommodated in the reserve cup 30. The reserve cup 30 is attached to the fuel pump 20, and is disposed in the fuel tank 2. The reserve cup 30 has a tubular shape with a bottom. The reserve cup 30 is positioned on a bottom surface of the fuel tank 2. A jet pump, which is not shown, is attached to a lower end of the reserve cup 30. While the fuel pump 20 is operating, the jet pump causes fuel that is present outside the reserve cup 30 to flow into the reserve cup 30 by using a part of fuel discharged from the fuel pump 20. Due to this, a fuel level in the reserve cup 30 can be kept at a relatively high position, even if a fuel level in the fuel tank 2 is lowered.

The fuel filter 50 is disposed between an outer circumferential surface of the fuel pump 20 and an inner circumferential surface of the reserve cup 30. A suction pipe 62 which communicates with a suction hole of the fuel pump 20 is attached to the fuel filter 50. One end of the suction pipe 62 is fixed to an end portion of the fuel filter 50 on a bottom side of the fuel tank 2. Further, the other end of the suction pipe 62 comprises a holder 60 covering an end portion of the fuel pump 20 on the bottom side of the fuel tank 2. The fuel filter 50 removes foreign matter contained in fuel by filtering fuel sucked into the fuel pump 20 from the reserve cup 30. Due to this, foreign matter excluding fuel can be prevented from entering the fuel pump 20.

As shown in FIG. 2, the fuel filter 50 is bent in an arc-like shape along an outer circumference of the fuel pump 20 so as to surround the fuel pump 20. The fuel filter 50 is locked by the lock wall 24. The lock wall 24 is fixed to three arms 22 extending from the fuel pump 20 toward the reserve cup 30. Notably, the arms 22 are fixed to an upper end of the fuel pump 20. The lock wall 24 extends parallel to the Z axial direction from the arms 22 toward the bottom of the fuel tank 2. The lock wall 24 has an arc-like shape along the outer circumference of the fuel pump 20.

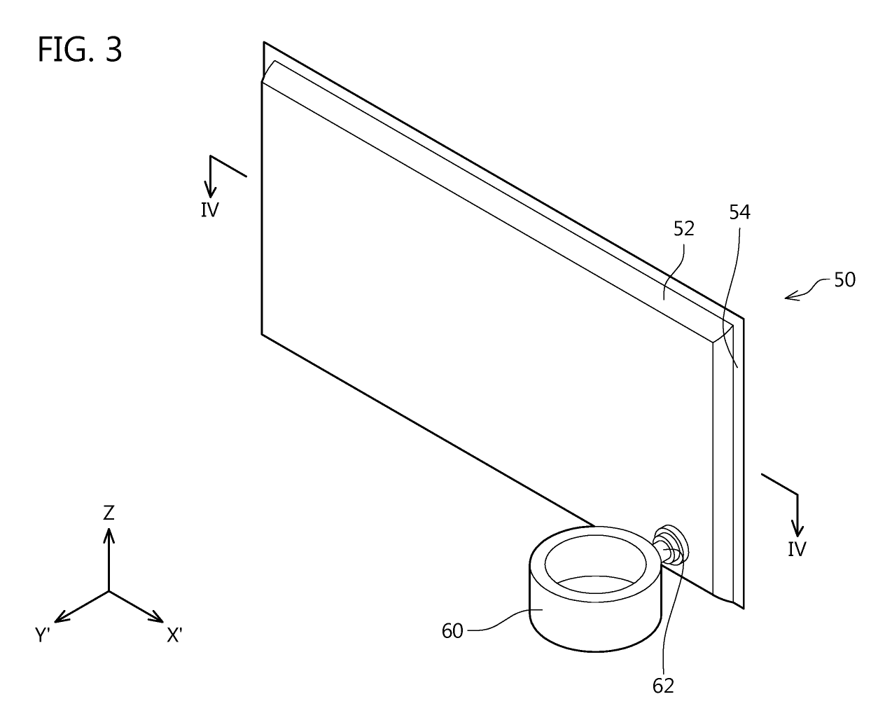

Referring to FIGS. 3-6, the fuel filter 50 will be described. FIG. 3 shows a perspective view of the fuel filter 50 before being assembled in the fuel supply device 10 as a component of the fuel supply device 10. As shown in FIG. 3, the fuel filter 50 prior to the assembly is not bent, and has a flat plate shape. The fuel filter 50 has a bag shape and a frame 70 is disposed inside a filter 52. Outer peripheral edges 54 of the filter 52 are closed by welding.

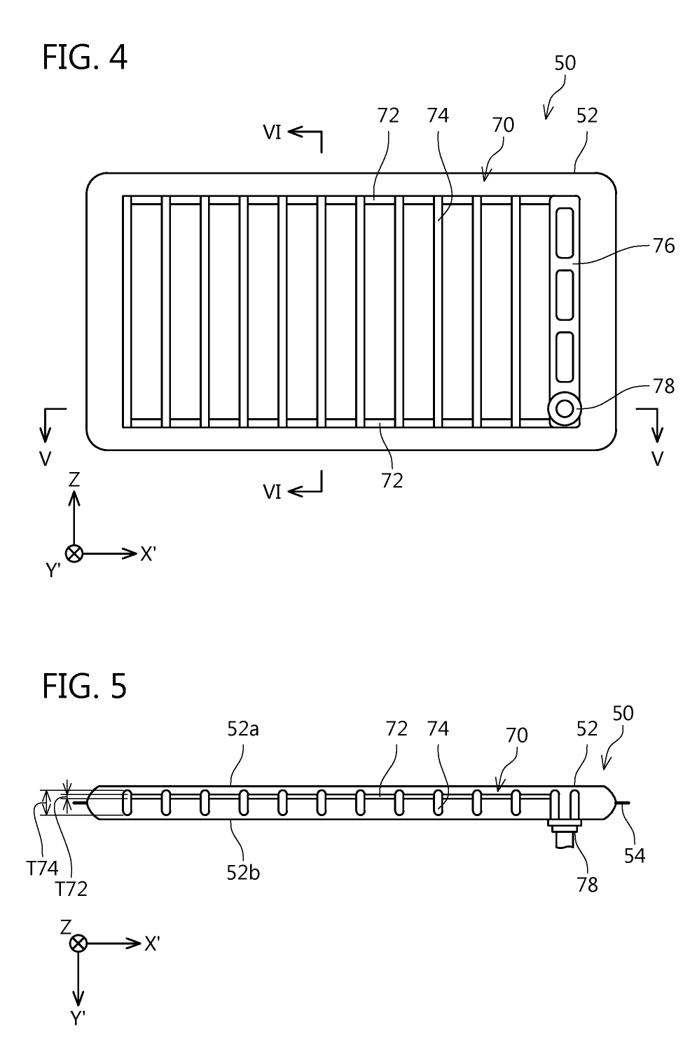

As shown in FIG. 4 and FIG. 5, the frame 70 is housed inside the filter 52. The filter 52 comprises a pair of filter members 52a and 52b which face each other. The filter members 52a and 52b face each other with an interval therebetween in a Y′ axial direction. The outer peripheral edges 54 of the filter members 52a and 52b are closed by welding. The frame 70 maintains the gap between the filter members 52a and 52b, and keeps a shape of the filter 52. Notably, although details will be described later, the filter 52 is formed by folding a single sheet and welding overlapped portions of the single sheet. Thus, the filter members 52a and 52b were originally the same single sheet.

The frame 70 is made of resin and integrally formed. The frame 70 comprises a plurality of first frame members 74, two second frame members 72, and a connection frame member 76. Each of the first frame members 74 extends along the Z axial direction. The first frame members 74 are disposed at intervals in an X′ axial direction. The connection frame member 76 extends along the Z axial direction and is disposed so as to be spaced from the first frame members 74 in the X′ axial direction. The connection frame member 76 can also be regarded as one of the first frame members. The connection frame member 76 comprises a connection opening 78 that is to be connected to the suction pipe 62 (refer to FIGS. 1-3 as well). The second frame members 72 are connected to the first frame members 74 and the connection frame member 76 at both ends in the Z axial direction of each first frame member 74 and the connection frame member 76. Notably, the X′ axial direction is an example of a third direction in the claims, the Y′ axial direction is an example of a first direction in the claims, and the Z axial direction is an example of a second direction in the claims.

As shown in FIG. 5, a thickness T74 (a length in the Y′ axial direction) of each of the first frame members 74 is thicker than a thickness T72 of each of the second frame members 72. The first frame members 74 have a greater rigidity (have a greater strength) than the second frame members 72. In other words, the frame 70 has a greater strength in the Z axial direction than in the X′ axial direction. Due to this, the fuel filter 50 can be easily deformed on an X′-Y′ plane while maintaining the strength in the Z axial direction (refer to FIG. 2 as well). Notably, as apparent from FIG. 4, an interval between adjacent second frame members 72 (an interval between the two second frame members 72) is wider than an interval between each pair of adjacent first frame members 74. More specifically, the second frame members 72 are connected to the first frame members 74 only at both ends of each of the first frame members 74, and no second frame member 72 is provided in a middle portion of each of the first flame members 74. Such configuration also contributes to the greater strength of the frame 70 in the Z axial direction than in the X′ axial direction.

As shown in FIG. 1, the fuel filter 50 is disposed in a state where the fuel filter 50 is bent (curved) along the outer circumference of the fuel pump 20. An external size of the fuel supply device 10 can be reduced by bending the fuel filter 50. The reduction in size of the fuel supply device 10 makes it easier to have the fuel supply device 10 pass through the opening 2a of the fuel tank 2 and dispose it in the fuel tank 2 (refer to FIG. 1 as well).

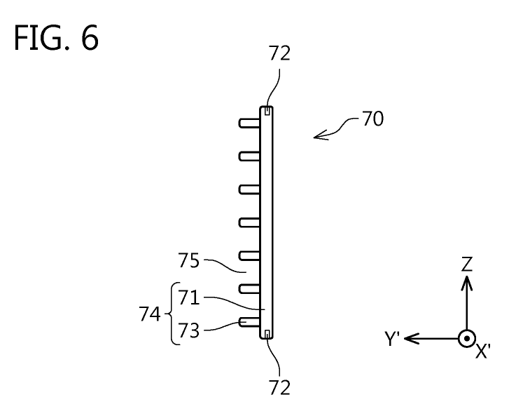

Here, other features of the frame 70 will be described. As shown in FIG. 6, each of the first frame members 74 comprises a straight portion 71 and a plurality of protrusions 73 extending from the straight portion 71 in the Y′ axial direction. Due to this, even if the first frame members 74 come in contact with both of the filter members 52a and 52b, fuel is allowed to move in the fuel filter 50. Each clearance between the protrusions 73 functions as a flow path 75 for fuel.

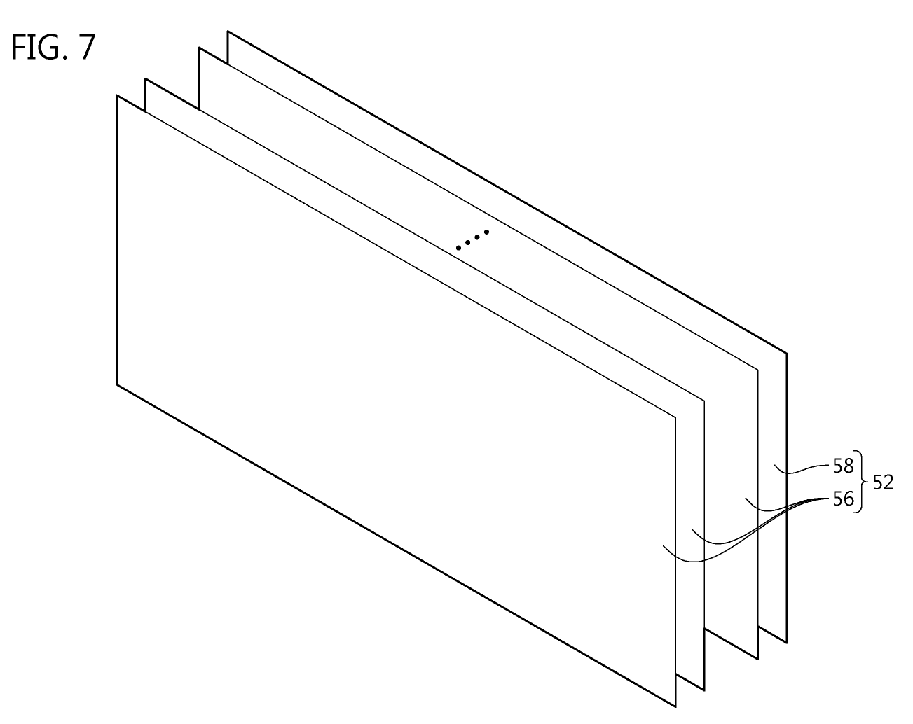

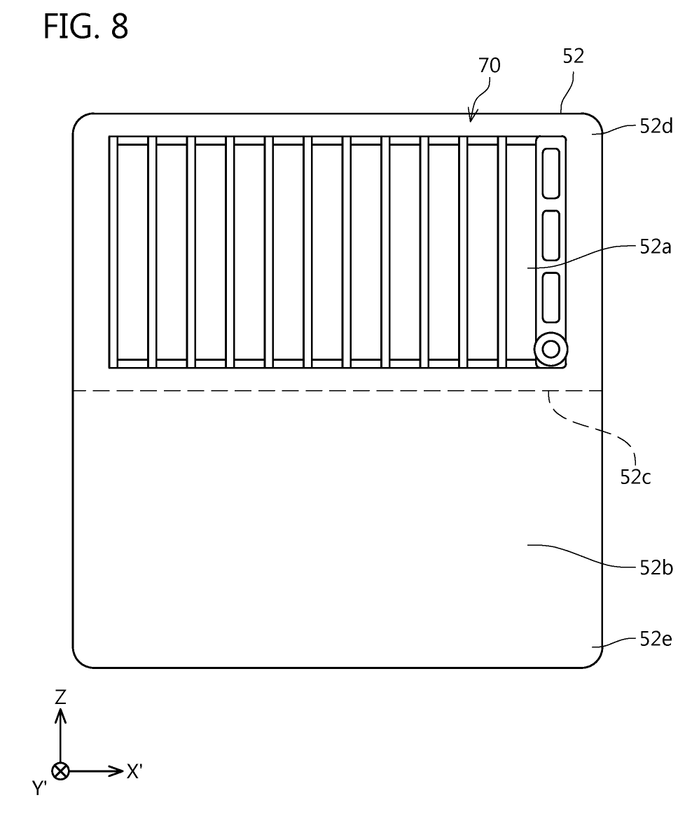

Here, the fuel filter 50 will be further described referring to FIG. 7 and FIG. 8. The filter 52 has a laminated structure where a plurality of sheets is laminated. Specifically, the filter 52 comprises a plurality of filter sheets 56 and a protection sheet 58. The filter sheets 56 are non-woven cloths made of thermoplastic resin. The filter sheets 56 have the same shape and are laminated on one another. The protection sheet 58 is a meshed, thin film made of thermoplastic resin. The protection sheet 58 covers the filter sheet 56 located outermost among the laminated filter sheets 56. The protection sheet 58 has the same shape as the filter sheets 56 and prevents the filter sheets 56 from being exposed. The fuel filter 50 is formed by the following processes. The filter 52 is folded in half at a center line 52c with the frame 70 disposed on an upper portion of the filter 52 such that a corner 52d and a corner 52e are overlapped. In that state, the outer peripheral edges of the filter 52 are welded to complete the fuel filter 50. That is, the upper portion of the filter 52 configures the filter member 52a and a lower portion of the filter 52 configures the filter member 52b.

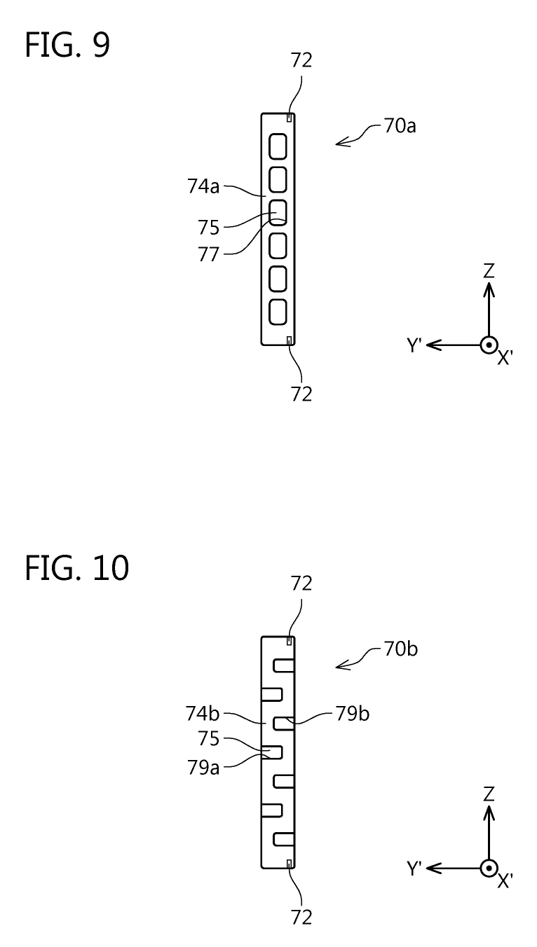

Referring to FIG. 9, a fuel filter of a second embodiment will be described. The fuel filter of the present embodiment is a modification example of the fuel filter 50 and a shape of a frame 70a is different from that of the frame 70 of the fuel filter 50. Hereinbelow, features of the frame 70a that are different from those of the frame 70 will be described. The features same as the frame 70 may be denoted by the same reference numbers or reference numbers having the same two last digits, and descriptions thereof may be omitted. Notably, FIG. 9 corresponds to the cross sectional view of the frame 70 shown in FIG. 6. The frame 70a comprises first frame members 74a and the second frame members 72. Each first frame member 74a is provided with a plurality of through holes 77. The through holes 77 extend in the X′ axial direction. The through holes 77 are juxtaposed in the Z axial direction. An inside of each through hole 77 functions as the flow path 75 for fuel.

Referring to FIG. 10, a fuel filter of a third embodiment will be described. The fuel filter of the present embodiment is a modification example of the fuel filter 50 and a shape of a flame 70b is different from that of the frame 70 of the fuel filter 50. Hereinbelow, features of the frame 70b that are different from those of the frame 70 will be described. The features same as the frame 70 may be denoted by the same reference numbers or reference numbers having the same two last digits, and descriptions thereof may be omitted. Notably, FIG. 10 corresponds to the cross sectional view of the frame 70 shown in FIG. 6.

The frame 70b comprises first fume members 74b and the second fume members 72. Each first frame member 74b is provided with a plurality of first grooves 79a and a plurality of second grooves 79b. The first grooves 79a extend in the Y′ axial direction from a surface of the first frame member 74b on a filter member 52b side (refer to FIG. 5 as well). The second grooves 79b extend in the Y′ axial direction from a surface of the first frame member 74b on a filter member 52a side. The first grooves 79a and the second grooves 79b penetrate the first frame member 74b in the X′ axial direction. The first grooves 79a and the second grooves 79b are arranged alternately next to each other in the Z axial direction. An inside of each groove 79a and an inside of each groove 79b function as the flow path 75 for fuel.

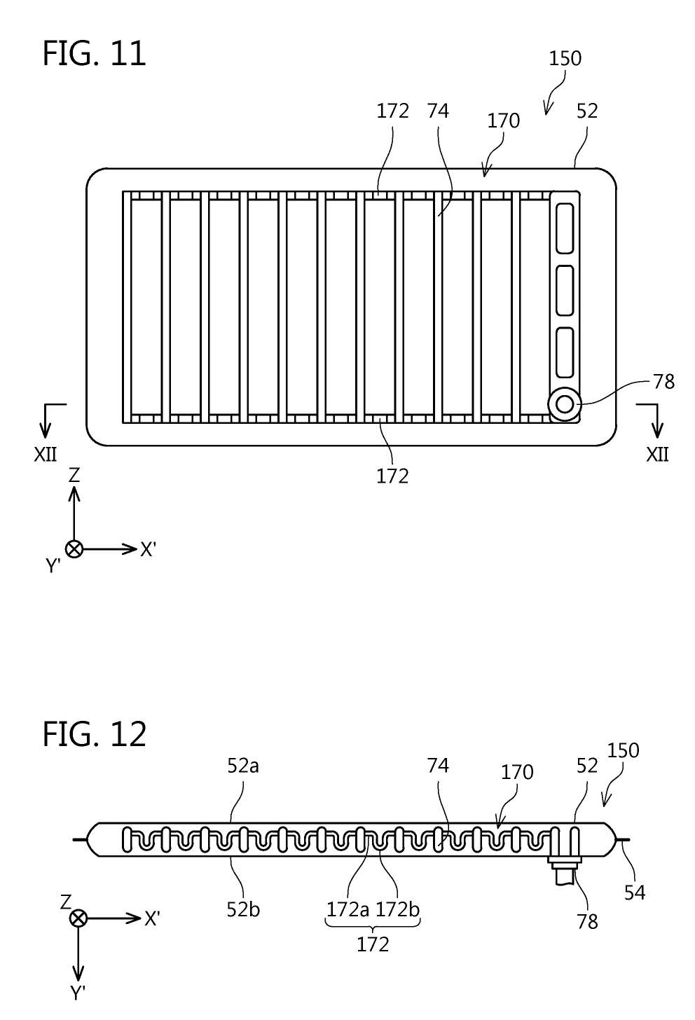

Referring to FIG. 11 and FIG. 12, a fuel filter 150 of a fourth embodiment will be described. The fuel filter 150 is a modification example of the fuel filter 50 and a shape of a frame 170 is different from that of the frame 70 of the fuel filter 50. Hereinbelow, features of the frame 170 that are different from those of the frame 70 will be described. The features same as the frame 70 may be denoted by the same reference numbers or reference numbers having the same two last digits, and descriptions thereof may be omitted. Notably, FIG. 11 and FIG. 12 correspond to the cross sectional views of the fuel filter 50 shown in FIG. 4 and FIG. 5, respectively.

The frame 170 comprises the first frame members 74 and second frame members 172. Each of the second frame members 172 comprises straight portions 172a and bent portions 172b. The straight portions 172a extend in the X′ axial direction, and the bent portions 172b extend in the Y′ axial direction. The straight portions 172a and the bent portions 172b are alternately provided. The first frame members 74 are fixed to the straight portions 172a. Due to this, each bent portion 172b is located between a corresponding pair of the first frame members 74 in the X′ axial direction. Since the second frame members 172 comprise the bent portions 172b, an overall length of each second frame member 172 is longer compared to that of each second frame member 72 of the frame 70 (refer to FIG. 4). Due to this, compared to the fuel filter 50, the fuel filter 150 is easy to be bent when disposed into the fuel tank 2 (refer to FIG. 2 as well). Further, by the overall length of each second frame member 172 being longer than that of each second frame member 72, strain by deformation caused when the fuel filter 150 is bent can be dispersed.

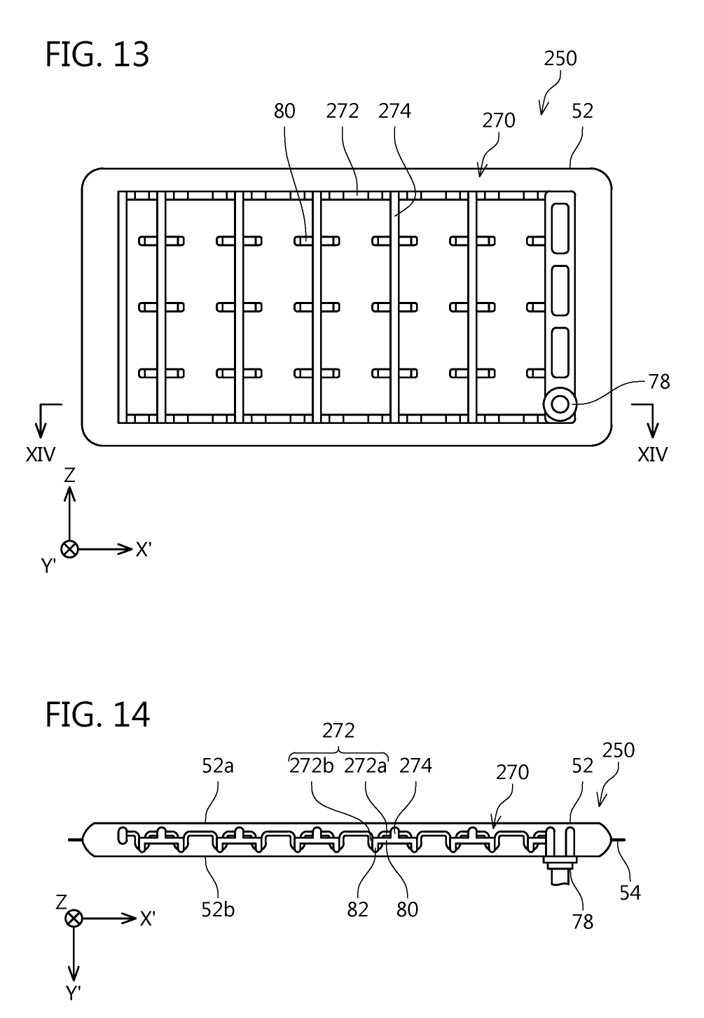

Referring to FIG. 13 and FIG. 14, a fuel filter 250 of a fifth embodiment will be described. The fuel filter 250 is a modification example of the fuel filter 150 and a shape of a frame 270 is different from that of the frame 170 of the fuel filter 150. Hereinbelow, features of the fuel filter 250 that are different from those of the fuel filter 150 will be described. The features same as the fuel filter 150 may be denoted by the same reference numbers or reference numbers having the same two last digits, and descriptions thereof may be omitted. Notably, FIG. 13 and FIG. 14 correspond to the cross sectional views of the fuel filter 150 shown in FIG. 11 and FIG. 12, respectively.

The frame 270 comprises first frame members 274 and second frame members 272. Each first frame member 274 is provided with extension portions 80 at its middle portion in the Y′ axial direction. The extension portions 80 in plurality are juxtaposed in the Z axial direction. Each extension portion 80 extends toward both orientations in the X′ axial direction. Notably, each extension portion 80 is not in contact with the adjacent first frame member(s) 274 (corresponding extension portion(s) 80 provided on the adjacent first frame member(s) 274). Due to this, even when the fuel filter 250 is bent to be disposed into the fuel tank 2, the extension portions 80 do not come in contact with each other. That is, flexibility of the fuel filter 250 is not decreased, even if the extension portions 80 are provided. Protruding portions 82 protruding toward the Y′ axial direction is provided at both ends in the X′ axial direction of each extension portion 80. The protruding portions 82 make contact with the filter member 52b and maintain the gap between the filter members 52a and 52b. In the frame 270, one first frame member 274 is able to make contact with the filter member 52b at two points.

The second frame members 272 are substantially same as the second frame members 172 (refer to FIGS. 11 and 12 as well). However, in the frame 270, each of the first frame members 274 is connected to every other straight portion 272a. That is, between each pair of the straight portions 272a to which the first frame members 274 are respectively connected, there is one straight portion 272a to which no first frame member 274 is connected. In other words, in the X′ axial direction, two bent portions 272b are provided between each pair of the straight portions 272a to which the first frame members 274 are respectively connected. As mentioned above, in the frame 270, each first frame member 274 is connected to every other straight portion 272a. Due to this, a number of the first frame members can be reduced in the frame 270 compared to the frame 170 (refer to FIG. 11). Specifically, the number of the first frame members 274 in the frame 270 is half the number of the first frame members 174 in the flume 170. Compared to the frame 170, the frame 270 can have a lighter weight.

Notably, as mentioned above, in the frame 270, one first frame member 274 is able to make contact with the filter member 52b at two points. Due to this, in the frame 270, a number of points at which the first frame members make contact with the filter member 52b in the X′ axial direction can be made equal to that in the frame 170, while the number of the first frame members 274 is half the number of the first flame members of the frame 170. That is, despite the frame 270 having a lighter weight than the flame 170, the frame 270 can keep the function of maintaining the gap between the filter members 52a and 52b at the same degree as the frame 170.

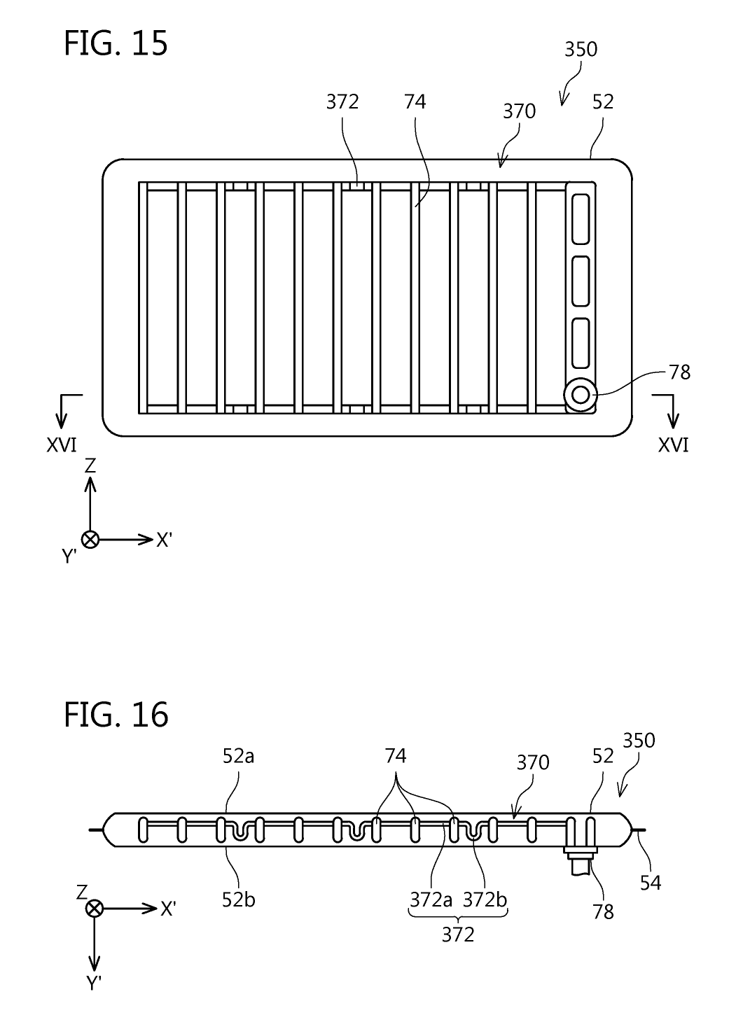

Referring to FIG. 15 and FIG. 16, a fuel filter 350 of a sixth embodiment will be described. The fuel filter 350 is a modification example of the fuel filter 150 and a shape of a frame 370 is different from that of the flame 170 of the fuel filter 150. Hereinbelow, features of the fuel filter 350 that are different from those of the fuel filter 150 will be described. The features same as the fuel filter 150 may be denoted by the same reference numbers or reference numbers having the same two last digits, and descriptions thereof may be omitted. Notably, FIG. 15 and FIG. 16 correspond to the cross sectional views of the fuel filter 150 shown in FIG. 11 and FIG. 12, respectively.

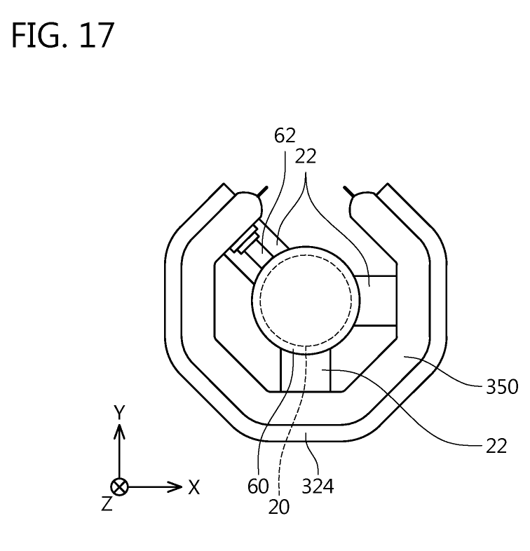

The frame 370 comprises the first frame members 74 and second frame members 372. Each of the second frame members 372 comprises straight portions 372a and bent portions 372b. Three first frame members 74 are connected to each one of the straight portions 372a (each one of the straight portions 372a between adjacent bent portions 372b). However, intervals between the first frame members 74 in the X′ axial direction in the frame 370 are equal to the intervals between the first frame members 74 in the frame 170. That is, a length of each straight portion 372a of the frame 370 is longer than that of each straight portion 172a of the frame 170. Due to this, as shown in FIG. 17, when the fuel filter 350 is disposed in the fuel tank, the fuel filter 350 forms a part of a polygon around the fuel pump 20. In this case, the fuel filter 350 is locked by a polygonal lock wall 324. 100371 Notably, in the fuel filters 150 and 350, the first frame members 74a of the frame 70a or the first frame members 74b of the frame 70b may be used instead of the first frame members 74.

Specific examples of the present disclosure have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. A fuel filter disposed in a fuel tank and configured to remove foreign matter contained in fuel sucked into a fuel pump, the fuel filter comprising:
a pair of filter members facing each other and outer peripheral edges of which are closed; and
a flame housed in the pair of the filter members and maintaining a gap between the pair of the filter members,
wherein the frame comprises:
a plurality of first frame members extending along a second direction perpendicular to a first direction in which the pair of the filter members face each other, and the first frame members being disposed at intervals in a third direction perpendicular to the first direction and the second direction; and
a second frame member extending along the third direction and connected to each of the first frame members, and
the flame has a greater strength in the second direction than in the third direction.

2. The fuel filter according to claim 1, comprising
a plurality of the second frame members,
wherein an interval between adjacent ones of the second flame members is wider than an interval between adjacent ones of the first frame members.

3. The fuel filter according to claim 2, wherein
the plurality of the second frame members is two second frame members, and
the two second flume members are connected to the first frame members at both ends of each of the first frame members.

4. The fuel filter according to claim 3, wherein
a length of each of the first frame members in the first direction is longer than a length of each of the second frame members in the first direction.

5. The fuel filter according to claim 4, wherein
the first frame members are provided with a flow path through which fuel moves in the third direction.

6. The fuel filter according to claim 5, wherein
at least one of the first frame members is provided with an extension portion extending toward the third direction, and
the extension portion is not in contact with the first frame member adjacent thereto.

7. The fuel filter according to claim 6, wherein
at least one of the second frame members comprises a bent portion bending toward the first direction between the adjacent first frame members.

8. The fuel filter according to claim 1, wherein
at least one of the first frame members is provided with an extension portion extending toward the third direction, and
the extension portion is not in contact with the first frame member adjacent thereto.

9. The fuel filter according to claim 1, wherein
the second frame member comprises a bent portion bending toward the first direction between adjacent ones of the first frame members.
